(19) United States
(12) Patent Application Publication
(10) Pub. No.: US 2021/0079243 A1
(43) Pub. Date: Mar. 18, 2021

(54) ACTIVE-ENERGY-RAY-CURABLE COMPOSITION, ACTIVE-ENERGY-RAY-CURABLE INK, ACTIVE-ENERGY-RAY-CURABLE INKJET INK, STORED CONTAINER, TWO-DIMENSIONAL OR THREE-DIMENSIONAL IMAGE FORMING APPARATUS, TWO- DIMENSIONAL OR THREE-DIMENSIONAL IMAGE FORMING METHOD, AND CURED PRODUCT

(71) Applicant: Hidetoshi FUJII, Kanagawa (JP)

(72) Inventor: Hidetoshi FUJII, Kanagawa (JP)

(21) Appl. No.: 17/021,437

(22) Filed: Sep. 15, 2020

(30) Foreign Application Priority Data
Sep. 17, 2019 (JP) 2019-168665
Jul. 29, 2020 (JP) 2020-128568

(51) Int. Cl. C09D 11/101; C09D 11/102; C09D 11/38; C08L 75/04

(52) U.S. Cl. CPC C09D 11/101; C09D 11/102; B33Y 70/00; C08L 75/04; C09D 11/38

(57) ABSTRACT

An active-energy-ray-curable composition is provided that includes an active-energy-ray-polymerizable compound, an amine compound, and water. The active-energy-ray-polymerizable compound comprises resin particles having a 50% cumulative particle diameter (D50) of 5 nm or greater but 50 nm or less. The amine compound has a molecular weight of 118.0 or less and a boiling point of 120 degrees C. or higher. The proportion of the water in the active-energy-ray-curable composition is 50.0 percent by mass or greater.

### CROSS-REFERENCE TO RELATED APPLICATIONS

This patent application is based on and claims priority pursuant to 35 U.S.C. § 119(a) to Japanese Patent Application No. 2019-168665, filed on Sep. 17, 2019 and Japanese Patent Application No. 2020-128568, filed on Jul. 29, 2020, in the Japan Patent Office, the entire disclosure of which is hereby incorporated by reference herein.

### BACKGROUND

### Technical Field

The present disclosure relates to an active-energy-ray-curable composition, an active-energy-ray-curable ink, an active-energy-ray-curable inkjet ink, a stored container, a two-dimensional or three-dimensional image forming apparatus, a two-dimensional or three-dimensional image forming method, and a cured product.

### Description of the Related Art

Inkjet recording apparatuses have advantages such as low noise, low running cost, and ease of color printing and have become widespread in general households as digital signal output devices. Inks obtained by dissolving or dispersing coloring materials in aqueous media or organic solvents have been known as inks used in inkjet recording apparatuses. From environment and safety-related viewpoints, inks containing water and water-soluble organic solvents are suitable for office or home use.

### SUMMARY

According to an aspect of the present disclosure, an active-energy-ray-curable composition includes an active-energy-ray-polymerizable compound, an amine compound, and water. The active-energy-ray-polymerizable compound comprises resin particles having a 50% cumulative particle diameter (D50) of 5 nm or greater but 50 nm or less. The amine compound has a molecular weight of 118.0 or less and a boiling point of 120 degrees C. or higher. The proportion of the water in the active-energy-ray-curable composition is 50.0 percent by mass or greater.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example of an image forming apparatus according to an embodiment of the present disclosure;

FIG. 2 is a schematic view illustrating another example of an image forming apparatus according to an embodiment of the present disclosure; and

FIGS. 3A to 3D are schematic views illustrating another example of an image forming apparatus according to an embodiment of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The active-energy-ray-curable composition of the present disclosure has excellent effects in terms of scratch resistance, dischargeability, and storage stability.

An example of an embodiment of the present disclosure will be described below.

### <<Active-Energy-Ray-Curable Composition>>

An active-energy-ray-curable composition of the present embodiment contains an active-energy-ray-polymerizable compound, an amine compound, and water, and contains other components such as a polymerization initiator, an organic solvent, a coloring material, a resin, and an additive as needed.

### <Active-Energy-Ray-Polymerizable Compound>

The active-energy-ray-curable composition contains an active-energy-ray-polymerizable compound in the form of resin particles, and may further contain, for example, an active-energy-ray-polymerizable monomer as needed.

### —Active-Energy-Ray-Polymerizable Compound Contained in Form of Resin Particles—

The active-energy-ray-polymerizable compound (hereinafter may also be referred to simply as “active-energy-ray-polymerizable polymer”) contained in the form of resin particles is a resin containing a polymerizable group that can undergo a polymerization reaction when active energy rays such as ultraviolet rays and heat are applied. The state of “being contained in the form of resin particles” means a state of the active-energy-ray-polymerizable polymer being contained in the form of particles in the active-energy-ray-polymerizable compound. It is preferable that the active-energy-ray-polymerizable polymer be contained in a dispersed state in the form of particles.

Problems hitherto involved in applying aqueous compositions having a water proportion of 50.0 percent by mass or greater over, for example, impermeable or poorly permeable recording media for forming coating films derived from active-energy-ray-curable compositions have been scratch resistance-related problems such as coating film peeling and coating film stretching when the coating films thus formed are scratched. Scratch resistance of coating films is improved through addition of active-energy-ray-polymerizable polymers in the compositions and irradiation of the compositions with active energy rays after application of the compositions.

The active-energy-ray-polymerizable polymer is not particularly limited and may be appropriately selected depending on the intended purpose. For example, a water-dispersible active-energy-ray-polymerizable polymer is preferable. The water-dispersible active-energy-ray-polymerizable polymer is preferably, for example, a water-dispersible active-energy-ray-polymerizable urethane resin. Examples of the active-energy-ray-polymerizable urethane resin include, but are not limited to, a water-dispersible (meth)acrylated urethane resin.

The water-dispersible (meth)acrylated urethane resin is not particularly limited and may be appropriately selected depending on the intended purpose. Examples of the water-dispersible (meth)acrylated urethane resin include, but are not limited to, UCECOAT (registered trademark) 6558 (available from Daicel-Allnex Ltd.), UCECOAT (registered trademark) 6559 (available from Daicel-Allnex Ltd.), EBECRYL (registered trademark) 2002 (available from Daicel-Allnex Ltd.), EBECRYL (registered trademark) 2003 (available from Daicel-Allnex Ltd.), UCECOAT (registered trademark) 7710 (available from Daicel-Allnex Ltd.), UCECOAT (registered trademark) 7655 (available from Daicel-Allnex Ltd.), NEORADR (registered trademark) 440 (available from AVECIA), NEORADR (registered trademark) 441 (available from AVECIA), NEORADR (registered trademark) 447 (available from AVECIA), NEORADR (registered trademark) 448 (available from AVECIA), BAYHYDROL (registered trademark) UV2317 (available from COVESTRO AG), BAYHYDROL (registered trademark) UV VP LS2348 (available from COVESTRO AG), LUX (registered trademark) 430 (available from ALBERDING BOLEY Inc.), LUX (registered trademark) 399 (available from ALBERDING BOLEY Inc.), LUX (registered trademark) 484 (available from ALBERDING BOLEY Inc.), LAROMER (registered trademark) LR8949 (available from BASF Japan Ltd.), LAROMER (registered trademark) LR8983 (available from BASF Japan Ltd.), LAROMER (registered trademark) PE22WN (available from BASF Japan Ltd.), LAROMER (registered trademark) PE55WN (available from BASF Japan Ltd.), and LAROMER (registered trademark) UA9060 (available from BASF Japan Ltd.). Among these water-dispersible (meth)acrylated urethane resins, LAROMER (registered trademark) LR8949 (available from BASF Japan Ltd.) and LAROMER (registered trademark) LR8983 (available from BASF Japan Ltd.) are preferable because scratch resistance can be better improved. One of these water-dispersible (meth)acrylated urethane resins may be used alone or two or more of these water-dispersible (meth)acrylated urethane resins may be used in combination.

The proportion of the active-energy-ray-polymerizable polymer as a solid content in the active-energy-ray-curable composition is preferably 2.0 percent by mass or greater but 12.0 percent by mass or less and more preferably 6.0 percent by mass or greater but 12.0 percent by mass or less. When the proportion of the active-energy-ray-polymerizable polymer is in the range described above, scratch resistance can be better improved.

The 50% cumulative particle diameter (D50) of the active-energy-ray-polymerizable polymer is 5 nm or greater but 50 nm or less. When the 50% cumulative particle diameter (D50) is in the range described above, scratch resistance is improved. The 50% cumulative particle diameter (D50) indicates a 50% cumulative volume-based particle diameter counted from a smaller particle side in a cumulative particle size distribution. The 50% cumulative particle diameter (D50) can be measured with, for example, a particle size distribution analyzer (available from Nikkiso Co., Ltd., NANOTRAC UPA-EX150).

### —Active-Energy-Ray-Polymerizable Monomer—

An active-energy-ray-polymerizable monomer is a monomer containing a polymerizable group that can undergo a polymerization reaction when active energy rays such as ultraviolet rays and heat are applied.

The active-energy-ray-polymerizable monomer is not particularly limited and may be appropriately selected depending on the intended purpose. For example, (meth)acrylate, (meth)acrylamide, and vinyl ether can be used. More specific examples of the active-energy-ray-polymerizable monomer include, but are not limited to, ethylene glycol di(meth)acrylate, hydroxypivalic acid neopentyl glycol di(meth)acrylate, γ-butyrolactone acrylate, isobornyl (meth)acrylate, formalized trimethylolpropane mono(meth)acrylate, polytetramethylene glycol di(meth)acrylate, trimethylolpropane (meth)acrylic acid benzoic acid ester, triethylene glycol di(meth)acrylate, tetraethylene glycol di(meth)acrylate, polyethylene glycol diacrylate [CH₂═CH—CO—(OC₂H₄)n-OCOCH═CH₂ (n≈4)], polyethylene glycol diacrylate [CH₂═CH—CO—(OC₂H₄)n-OCOCH═CH₂ (n≈9)], polyethylene glycol diacrylate [CH₂═CH—CO—(OC₂H₄)n-OCOCH═CH₂ (n≈14)], polyethylene glycol diacrylate [CH₂═CH—CO—(OC₂H₄)n-OCOCH═CH₂ (n≈23)], dipropylene glycol di(meth)acrylate, tripropylene glycol di(meth)acrylate, polypropylene glycol dimethacrylate [CH₂═C(CH₃)—CO—(OC₃H₆)n-OCOC(CH₃)═CH₂ (n≈7)], 1,3-butanediol di(meth)acrylate, 1,4-butanediol diacrylate, 1,6-hexanediol di(meth)acrylate, 1,9-nonanediol di(meth)acrylate, neopentyl glycol diacrylate, tricyclodecane dimethanol diacrylate, propylene oxide-modified bisphenol A di(meth)acrylate, polyethylene glycol di(meth)acrylate, dipentaerythritol hexa(meth)acrylate, (meth)acryloylmorpholine, propylene oxide-modified tetramethylolmethane tetra(meth)acrylate, dipentaerythritol hydroxy penta(meth)acrylate, caprolactone-modified dipentaerythritol hydroxy penta(meth)acrylate, ditrimethylolpropane tetra(meth)acrylate, pentaerythritol tetra(meth)acrylate, trimethylolpropane triacrylate, ethylene oxide-modified trimethylolpropane tri(meth)acrylate, propylene oxide-modified trimethylolpropane tri(meth)acrylate, caprolactone-modified trimethylolpropane tri(meth)acrylate, pentaerythritol tri(meth)acrylate, tris(2-hydroxyethyl)isocyanurate tri(meth)acrylate, neopentyl glycol diacrylate, ethoxylated neopentyl glycol di(meth)acrylate, propylene oxide-modified neopentyl glycol di(meth)acrylate, propylene oxide-modified glyceryl tri(meth)acrylate, polyester di(meth)acrylate, polyester tri(meth)acrylate, polyester tetra(meth)acrylate, polyester penta(meth)acrylate, polyester poly(meth)acrylate, polyurethane di(meth)acrylate, polyurethane tri(meth)acrylate, polyurethane tetra(meth)acrylate, polyurethane penta(meth)acrylate, polyurethane poly(meth)acrylate, 2-hydroxypropyl (meth)acrylamide, N-vinyl caprolactam, N-vinyl pyrrolidone, N-vinyl formamide, cyclohexane dimethanol monovinyl ether, cyclohexane dimethanol divinyl ether, hydroxyethyl vinyl ether, diethylene glycol monovinyl ether, diethylene glycol divinyl ether, dicyclopentadiene vinyl ether, tricyclodecane vinyl ether, benzyl vinyl ether, and ethyl oxetane methyl vinyl ether. One of these active-energy-ray-polymerizable monomers may be used alone or two or more of these active-energy-ray-polymerizable monomers may be used in combination. Any active-energy-ray-polymerizable monomer is appropriately selected and added considering, for example, solubility in water serving as a dispersion medium, the viscosity of the active-energy-ray-curable composition, and the thickness of the cured film (coating film) to be formed after application. In terms of solubility in water, acryloylmorpholine, dimethylaminopropyl acrylamide, polyethylene glycol, or polypropylene glycol-modified acrylate is preferable.

### <Amine Compound>

The active-energy-ray-curable composition contains an amine compound having a molecular weight of 118.0 or less and a boiling point of 120 degrees C. or higher. Examples of the amine compound include, but are not limited to, primary amines, secondary amines, tertiary amines, quaternary ammonium cations, and salts thereof.

Active-energy-ray-curable compositions containing an active-energy-ray-polymerizable polymer having a 50% cumulative particle diameter (D50) of 5 nm or greater but 50 nm or less have been problematic in the tendency toward degradation of dischargeability and storage stability due to degradation of dispersibility through evaporation of the moisture component thereof when the active-energy-ray-curable compositions have an interface of contact with air at, for example, discharging holes or are stored for a long term. Hence, an amine compound having a boiling point higher than water is added, to make the amine compound function as a counter ion of the active-energy-ray-polymerizable polymer, in order to maintain a stable dispersed state even when evaporation of water occurs and improve dischargeability and storage stability. Moreover, with addition of an amine compound having a low molecular weight, it is possible to suppress viscosity thickening of the active-energy-ray-curable composition even when evaporation of water occurs and better improve dischargeability and storage stability.

It is preferable that the amine compound contain at least one selected from compounds represented by General formula (1) below and compounds represented by General formula (2) below.

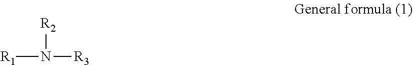

In General formula (1), R₁, R₂, and R₃ each independently represent a hydrogen atom, an alkoxy group containing from one through four carbon atoms, an alkyl group containing from one through six carbon atoms, or a hydroxyethyl group. However, all of R₁, R₂, and R₃ do not represent hydrogen atoms at the same time.

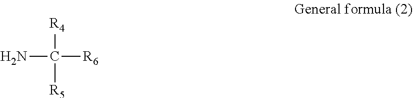

In General formula (2), R₄, R₅, and R₆ each independently represent a hydrogen atom, an alkyl group containing from one through four carbon atoms, or a hydroxymethyl group.

The amine compound is not particularly limited and may be appropriately selected depending on the intended purpose. Examples of the amine compound include, but are not limited to, 1-amino-2-propanol, 3-amino-1-propanol, N-methylethanolamine, N,N-dimethylethanolamine, 1-amino-2-methyl-propanol, dimethylaminoethanol, and 2-amino-2-methyl-1-propanol. Dimethylaminoethanol and 2-amino-2-methyl-1-propanol are preferable.

The molecular weight of the amine compound is 118.0 or less and preferably 100.0 or less. An amine compound having a low molecular weight can suppress viscosity thickening of the active-energy-ray-curable composition even when evaporation of water occurs, and better improve dischargeability and storage stability.

The boiling point of the amine compound is 120 degrees C. or higher, and preferably 120 degrees C. or higher but 200 degrees C. or lower. With addition of an amine compound having a boiling point higher than water to make the amine compound function as a counter ion of the active-energy-ray-polymerizable polymer, it is possible to maintain a stable dispersed state even when evaporation of water occurs and improve dischargeability and storage stability.

The proportion of the amine compound in the active-energy-ray-curable composition is preferably 0.01 percent by mass or greater but 5.0 percent by mass or less, more preferably 0.05 percent by mass or greater but 2.0 percent by mass or less, yet more preferably 0.05 percent by mass or greater but 1.0 percent by mass or less, and particularly preferably 0.05 percent by mass or greater but 0.5 percent by mass or less. Within this range, viscosity thickening of the active-energy-ray-curable composition can be suppressed even when evaporation of water occurs, and dischargeability and storage stability can be better improved.

The mass ratio of the amine compound to the active-energy-ray-polymerizable polymer is preferably 0.01 or greater but 0.10 or less, more preferably 0.01 or greater but 0.08 or less, yet more preferably 0.01 or greater but 0.06 or less, and particularly preferably 0.01 or greater but 0.04 or less. Within this range, viscosity thickening of the active-energy-ray-curable composition can be suppressed even when evaporation of water occurs, and dischargeability and storage stability can be better improved.

### <Water>

The active-energy-ray-curable composition contains water. The proportion of the water in the active-energy-ray-composition is preferably 50.0 percent by mass or greater but 95.0 percent by mass or less.

### <Polymerization Initiator>

The active-energy-ray-curable composition may contain a polymerization initiator. It is preferable that the polymerization initiator produce active species such as a radical or a cation upon application of energy of an active energy ray and initiate polymerization of a polymerizable compound. As the polymerization initiator, it is suitable to use a known radical polymerization initiator, cation polymerization initiator, base generator, or a combination thereof. Of these, a radical polymerization initiator is preferable. Moreover, the polymerization initiator preferably accounts for 5 percent by weight to 20 percent by weight of the mass of the active-energy-ray-curable composition to obtain sufficient curing speed.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, compounds having a carbon halogen bond(s), and alkyl amine compounds.

The active-energy-ray-curable composition is an aqueous composition having a water proportion of 50.0% by mass or greater. Therefore, it is preferable that the polymerization initiator contained in the active-energy-ray-curable composition have water solubility. As a water-soluble polymerization initiator, for example, a polymerization initiator containing a hydroxyl group in a molecule thereof is preferable. Specific examples of the polymerization initiator containing a hydroxyl group in a molecule thereof include, but are not limited to, alkylphenone-based polymerization initiators and monoacylphosphine oxide-based polymerization initiators.

In addition, a polymerization accelerator (sensitizer) is optionally used together with the polymerization initiator. The polymerization accelerator is not particularly limited. Examples of the polymerization accelerator include, but are not limited to, amine compounds such as trimethylamine, methyl dimethanolamine, triethanolamine, p-diethylaminoacetophenone, ethyl p-dimethylaminobenzoate, p-dimethylaminobenzoic acid-2-ethyl hexyl, N,N-dimethlbenzylamine, and 4,4′-bis(diethylamino)benzophenone. The proportion of the polymerization accelerator is appropriately set depending on the kind and the amount of the polymerization initiator used.

### <Organic Solvent>

The active-energy-ray-curable composition may contain an organic solvent. There is no specific limitation on the type of the organic solvent. For example, water-soluble organic solvents are suitable. Specific examples thereof include, but are not limited to, polyols, ethers such as polyol alkylethers and polyol arylethers, nitrogen-containing heterocyclic compounds, amides, amines, sulfur-containing compounds, and cyclic ethers.

Specific examples of polyols include, but are not limited to, ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol.

Specific examples of polyol alkylethers include, but are not limited to, ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether.

Specific examples of polyol arylethers include, but are not limited to, ethylene glycol monophenylether and ethylene glycol monobenzylether.

Specific examples of nitrogen-containing heterocyclic compounds include, but are not limited to, 2-pyrolidone, N-methyl-2-pyrolidone, N-hydroxyethyl-2-pyrolidone, 1,3-dimethyl-2-imidazolidinone, F-caprolactam, and γ-butyrolactone.

Specific examples of amides include, but are not limited to, formamide, N-methylformamide, N,N-dimethylformamide, 3-methoxy-N,N-dimethyl propionamide, and 3-butoxy-N,N-dimethyl propionamide.

Specific examples of amines include, but are not limited to, monoethanolamine, diethanolamine, and triethylamine.

Specific examples of sulfur-containing compounds include, but are not limited to, dimethyl sulfoxide, sulfolane, and thiodiethanol.

Specific examples of cyclic ethers include, but are not limited to, 3-hydroxymethyl-3-ethyloxetane.

Examples of other organic solvents include, but are not limited to, propylene carbonate and ethylene carbonate.

Since the organic solvent serves as a humectant and also imparts a good drying property, it is preferable to use an organic solvent having a boiling point of 250 degrees C. or lower.

Polyol compounds having eight or more carbon atoms and glycol ether compounds are also suitable as the organic solvent. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, diethylene glycol monomethylether, diethyleneglycol monoethylether, diethyleneglycol monobutylether, tetraethyleneglycol monomethylether, propylene glycol monomethylether, and propyleneglycol monoethylether; and polyol arylethers such as ethyleneglycol monophenylether and ethyleneglycol monobenzylether.

The polyol compounds having eight or more carbon atoms and glycolether compounds enhance the permeability of the active-energy-ray-curable composition when paper is used as a print medium.

The proportion of the organic solvent in the active-energy-ray-curable composition has no particular limit and can be suitably selected to suit a particular application. In terms of the drying property and discharging reliability of the active-energy-ray-curable composition, the proportion is preferably from 10 to 60 percent by mass and more preferably from 20 to 60 percent by mass relative to the total amount of the active-energy-ray-curable composition.

### <Coloring Material>

The active-energy-ray-curable composition may contain a coloring material. The coloring material has no particular limit. For example, pigments and dyes are suitable. The pigment includes inorganic pigments and organic pigments. These can be used alone or in combination. In addition, it is possible to use a mixed crystal.

As the pigments, for example, black pigments, yellow pigments, magenta pigments, cyan pigments, white pigments, green pigments, orange pigments, gloss pigments of gold, silver, etc., and metallic pigments can be used.

As the inorganic pigments, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black. Of these pigments, pigments having good affinity with solvents are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4 (Phthalocyanine Blue), 16, 17:1, 56, 60, and 63; and C.I. Pigment Green 1, 4, 7, 8, 10, 17, 18, and 36.

The type of dye is not particularly limited and includes, for example, acidic dyes, direct dyes, reactive dyes, and basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in the active-energy-ray-curable composition is preferably from 0.1 to 15 percent by mass and more preferably from 1 to 10 percent by mass relative to the total amount of the active-energy-ray-curable composition in terms of enhancement of image density, fixability, and discharging stability.

The pigment is dispersed by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group and carboxyl group to the pigment (e.g., carbon) to disperse the pigment in water.

To coat the surface of the pigment with resin, the pigment is encapsulated by microcapsules to make the pigment dispersible in water. This can be referred to as a resin-coated pigment. In this case, the pigment is not necessarily wholly coated with resin. Pigments partially or wholly uncovered with resin may be dispersed in the ink.

To use a dispersant, for example, a known dispersant of a small molecular weight type or a high molecular weight type represented by a surfactant is used to disperse the pigments in ink.

As the dispersant, it is possible to use, for example, anionic surfactants, cationic surfactants, nonionic surfactants, amphoteric surfactants, etc. depending on the pigments.

Also, a nonionic surfactant (RT-100, manufactured by TAKEMOTO OIL & FAT CO., LTD.) and a formalin condensate of naphthalene sodium sulfonate are suitable as dispersants.

These dispersants can be used alone or in combination.

### <Resin>

The active-energy-ray-curable composition may contain a resin. The type of the resin contained in the active-energy-ray-curable composition has no particular limit and can be suitably selected to suit to a particular application. Specific examples thereof include, but are not limited to, urethane resins, polyester resins, acrylic-based resins, vinyl acetate-based resins, styrene-based resins, butadiene-based resins, styrene-butadiene-based resins, vinyl chloride-based resins, acrylic styrene-based resins, and acrylic silicone-based resins.

Particles of such resins may be also used. The resin particle can be synthesized or is available on the market. These can be used alone or in combination of the resin particles.

The volume average particle diameter of the resin particle is not particularly limited and can be suitably selected to suit to a particular application. The volume average particle diameter is preferably from 10 to 1,000 nm, more preferably from 10 to 200 nm, and furthermore preferably from 10 to 100 nm to obtain good fixability and image hardness. The volume average particle diameter can be measured by using a particle size analyzer (Nanotrac Wave-UT151, manufactured by MicrotracBEL Corp.).

The proportion of the resin is not particularly limited and can be suitably selected to suit to a particular application. In terms of fixability and storage stability of the active-energy-ray-curable composition, it is preferably from 1 to 30 percent by mass and more preferably from 5 to 20 percent by mass to the total amount of the active-energy-ray-curable composition.

### <Surfactant>

The active-energy-ray-curable composition may contain a surfactant. Examples of the surfactant include, but are not limited to, silicone-based surfactants, fluorosurfactants, amphoteric surfactants, nonionic surfactants, and anionic surfactants.

The silicone-based surfactant has no specific limit and can be suitably selected to suit to a particular application. Among silicone-based surfactants, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as a silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These fluoro surfactants are particularly preferable because these fluoro surfactants do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxy ethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination.

The silicone-based surfactants have no particular limit and can be suitably selected to suit to a particular application. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant.

Any suitably synthesized surfactant and any product thereof available on the market is suitable. Products available on the market are obtained from Byk Chemie Japan Co., Ltd., Shin-Etsu Chemical Co., Ltd., Dow Corning Toray Silicone Co., Ltd., NIHON EMULSION Co., Ltd., Kyoeisha Chemical Co., Ltd., etc.

The polyether-modified silicone-based surfactant has no particular limit and can be suitably selected to suit to a particular application. Examples thereof include, but are not limited to, a compound in which the polyalkylene oxide structure represented by the following General formula S-1 is introduced into the side chain of the Si site of dimethyl polysiloxane.

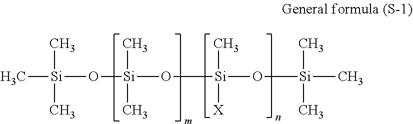

X═—R(C₂H₄O)ₐ(C₃H₆O)_{b}R′

In General formula S-1, “m”, “n”, “a”, and “b” each, respectively represent integers, R represents an alkylene group, and R′ represents an alkyl group.

Products available on the market may be used as the polyether-modified silicone-based surfactants. Specific examples of the products available on the market include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Silicone Co., Ltd.), BYK-33 and BYK-387 (both manufactured by Byk Chemie Japan Co., Ltd.), and TSF4440, TSF4452, and TSF4453 (all manufactured by Toshiba Silicone Co., Ltd.

A fluorosurfactant in which the number of carbon atoms replaced with fluorine atoms is from 2 to 16 and more preferably from 4 to 16 is preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain.

Of these fluorosurfactants, polyoxyalkylene ether polymer compounds having a perfluoroalkyl ether group in its side chain are preferable because these compounds do not foam easily and the fluorosurfactant represented by the following General formula F-1 or General formula F-2 is particularly preferable.

CF₃CF₂(CF₂CF₂)ₘ—CH₂CH₂O(CH₂CH₂O)ₙH General formula (F-1)

In General formula F-1, “m” is preferably 0 or an integer of from 1 to 10 and “n” is preferably 0 or an integer of from 1 to 40 in order to provide water solubility.

CₙF₂ₙ₊₁—CH₂CH(OH)CH₂—O—(CH₂CH₂O)ₙ—Y General formula (F-2)

In General formula F-2, Y represents H, CₘF₂ₘ₊₁, where “m” is an integer of from 1 to 6, CH₂CH(OH)CH₂—CₘF₂ₘ₊₁, where m represents an integer of from 4 to 6, or CₚH₂ₚ₊₁, where p represents an integer of from 1 to 19. “n” represents an integer of from 1 to 6. “a” represents an integer of from 4 to 14.

Products available on the market may be used as the fluorosurfactant. Specific examples of the products available on the market include, but are not limited to, SURFLON S-111, S-112, S-113, S-121, S-131, S-132, S-141, and S-145 (all available from AGC Inc.); FLUORAD FC-93, FC-95, FC-98, FC-129, FC-135, FC-170C, FC-430, and FC-431 (all available from Sumitomo 3M Limited); MEGAFAC F-470, F-1405, and F-474 (all available from DIC Corporation); ZONYL TBS, FSP, FSA, FSN-100, FSN, FSO-100, FSO, FS-300, and UR, and CAPSTONE FS-30, FS-31, FS-3100, FS-34, and FS-35 (all available from Chemours Company TT, LLC); FT-110, FT-250, FT-251, FT-400S, FT-150, and FT-400SW (all available from NEOS Company Limited.), POLYFOX PF-136A,PF-156A, PF-151N, PF-154, and PF-159 (available from OMNOVA SOLUTIONS INC.), and UNIDYNE DSN-403N (available from DAIKIN INDUSTRIES). Of these products, FS-3100, FS-34, and FS-300 (all available from Chemours Company TT, LLC), FT-110, FT-250, FT-251, FT-400S, FT-150, and FT-400SW (all available from NEOS Company Limited), POLYFOX PF-151N (available from OMNOVA SOLUTIONS INC.), and UNIDYNE DSN-403N (available from DAIKIN INDUSTRIES) are particularly preferable in terms of good printing quality, coloring in particular, and improvement on permeation, wettability, and uniform dyeing property to paper.

The proportion of the surfactant in the active-energy-ray-curable composition is not particularly limited and can be suitably selected to suit to a particular application. It is preferably from 0.001 to 5 percent by mass and more preferably from 0.05 to 5 percent by mass relative to the total amount of the ink in terms of excellent wettability and discharging stability and improvement on image quality.

### <Defoaming Agent>

The defoaming agent has no particular limit. For example, silicone-based defoaming agents, polyether-based defoaming agents, and aliphatic acid ester-based defoaming agents are suitable. These defoaming agents can be used alone or in combination. Of these defoaming agents, silicone-based defoaming agents are preferable to easily break foams.

### <Preservatives and Fungicides>

The preservatives and fungicides are not particularly limited. A specific example is 1,2-benzisothiazolin-3-on.

### <Corrosion Inhibitor>

The corrosion inhibitor has no particular limit. Examples thereof are acid sulfite and sodium thiosulfate.

### <Active Energy Rays>

Active energy rays used for curing the active-energy-ray-curable composition are not particularly limited, so long as they are able to give necessary energy for allowing polymerization reaction of polymerizable components in the composition to proceed. Examples of the active energy rays include, but are not limited to, electron beams, α-rays, ß-rays, γ-rays, and X-rays, in addition to ultraviolet rays. When alight source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable.

### <Preparation Method of Active-Energy-Ray-Curable Composition>

The active-energy-ray-curable composition can be produced by dispersing or dissolving the components described above in an aqueous medium, and stirring and mixing the components. Dispersion treatment may be performed using, for example, a ball mill, a kitty mill, a disk mill, a pin mill, and a DYNO-MILL.

### <Viscosity>

The viscosity of the active-energy-ray-curable composition have no particular limit because it can be adjusted depending on the purpose and application devices. For example, if an ejecting device that ejects the compositions from nozzles is employed, the viscosity thereof is preferably in the range of 3 mPa·s to 40 mPa·s, more preferably 5 mPa·s to 15 mPa·s, and particularly preferably 6 mPa·s to 12 mPa·s in the temperature range of 20 degrees C. to 65 degrees C., preferably at 25 degrees C. Incidentally, the viscosity can be measured by a cone plate rotary viscometer (VISCOMETER TVE-22L, manufactured by TOKI SANGYO CO., LTD.) using a cone rotor (1°34′×R24) at a number of rotation of 50 rpm with a setting of the temperature of hemathermal circulating water in the range of 20 degrees C. to 65 degrees C. VISCOMATE VM-150III can be used for the temperature adjustment of the circulating water.

### <Application Field>

The application field of the active-energy-ray-curable composition is not particularly limited. The active-energy-ray-curable composition can be applied to any field where active-energy-ray-curable compositions are used. For example, the active-energy-ray-curable composition is selected to a particular application and used for a resin for processing, a paint, an adhesive, an insulant, a releasing agent, a coating material, a sealing material, various resists, and various optical materials.

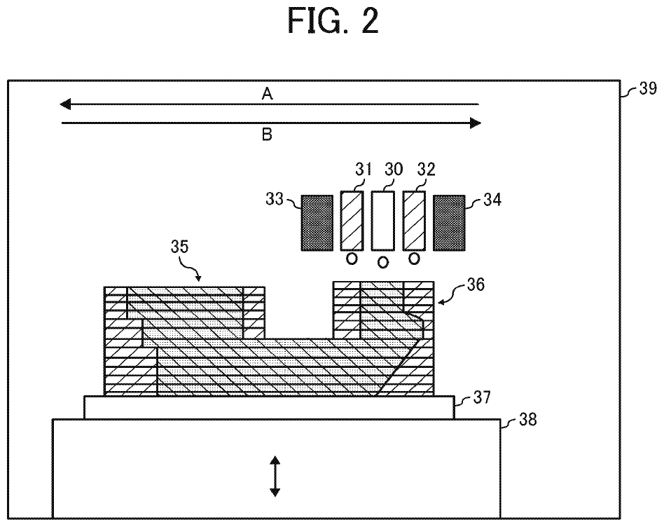

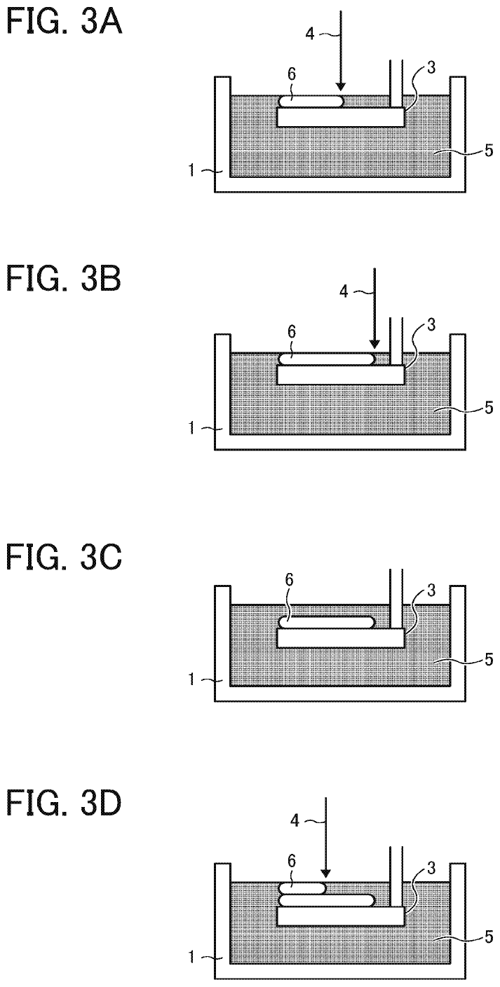

Furthermore, the active-energy-ray-curable composition can be used as an active-energy-ray-curable ink, and more preferably as an active-energy-ray-curable inkjet ink to form two-dimensional texts, images, and designed coating film on various substrates and in addition as a solid object forming material to form a three-dimensional object. This three dimensional object forming material may also be used as a binder for powder particles used in a powder layer laminating method of forming a three-dimensional object by repeating curing and layer-forming of powder layers, and as a three-dimensional object constituent material (a model material) and a supporting member used in an additive manufacturing method (a stereolithography method) as illustrated in FIG. 2 and FIGS. 3A to 3D. FIG. 2 is a diagram illustrating a method of additive manufacturing to sequentially form layers of the active-energy-ray-curable composition one on top of the other by repeating discharging the active-energy-ray-curable composition to particular areas followed by curing upon irradiation of an active energy ray (to be described in detail below). FIGS. 3A to 3D are diagrams illustrating a method of additive manufacturing to sequentially form cured layers 6 having respective predetermined forms one on top of the other on a movable stage 3 by irradiating a storing pool (storing part) 1 of the active-energy-ray-curable composition 5 with the active energy ray 4.

An apparatus for fabricating a three-dimensional object by the active-energy-ray-curable composition is not particularly limited and can be a known apparatus. For example, the apparatus includes a containing unit (stored container) containing the active-energy-ray-curable composition, a supplying unit configured to supply the active-energy-ray-curable composition from the containing unit, an applying unit configured to apply the active-energy-ray-curable composition supplied from the containing unit, and an irradiating unit configured to irradiate the active-energy-ray-curable composition applied with active-energy rays.

In addition, cured materials obtained by curing the active-energy-ray-curable composition (i.e., a cured product derived from the active-energy-ray-curable composition) include processed products obtained by processing the cured materials formed on a substrate. The processed product is fabricated by, for example, heat-drawing and punching a cured material or structure having a sheet-like form or film-like form. Examples thereof are products that need processing of the surface after decoration, such as gauges or operation panels of vehicles, office machines, electric and electronic machines, and cameras. In the present disclosure, a cured material formed on a substrate is referred to as a decorative part.

The substrate is not particularly limited. It can suitably be selected to a particular application. Examples thereof include paper, thread, fiber, fabrics, leather, metal, plastic, glass, wood, ceramic, or composite materials thereof. Of these, plastic substrates are preferred in terms of processability.

### <<Active-Energy-Ray-Curable Ink and Active-Energy-Ray-Curable Inkjet Ink>>

An active-energy-ray-curable ink is an ink containing the active-energy-ray-curable composition, and used in application fields in which two-dimensional texts and images are formed, application fields in which designed coating films are formed on various substrates, and application fields in which three-dimensional stereoscopic images (three-dimensional objects) are formed.

An active-energy-ray-curable inkjet ink is an active-energy-ray-curable ink used by inkjet discharging.

### <<Stored Container>>

A stored container contains the active-energy-ray-curable composition and is suitable for the applications as described above. For example, if the active-energy-ray-curable composition is used for an ink or an inkjet ink, a container that stores the ink can be used as an ink cartridge or an ink bottle. Therefore, users can avoid direct contact with the ink during operations such as transfer or replacement of the ink, so that fingers and clothes are prevented from contamination. Furthermore, inclusion of foreign matters such as dust in the ink can be prevented. In addition, the container can be of any size, any form, and any material. For example, the container can be designed to a particular application. It is preferable to use a light blocking material to block the light or cover a container with a light blocking sheet, etc.

### <<Image Forming Method and Image Forming Apparatus>>

An image forming method includes an applying step of applying the active-energy-ray-curable composition, the active-energy-ray-curable ink, or the active-energy-ray-curable inkjet ink (hereinafter, referred to as “for example, the active-energy-ray-curable composition”), and an irradiating step of irradiating, for example, the active-energy-ray-curable composition applied with active energy rays, and may further include other steps as needed.

An image forming apparatus includes a containing unit containing, for example, the active-energy-ray-curable composition, an applying unit configured to apply, for example, the active-energy-ray-curable composition contained, and an irradiating unit configured to irradiate, for example, the active-energy-ray-curable composition applied with active energy rays, and may further include other units as needed.

Examples of the applying step and the applying unit include a discharging step and a discharging unit. The discharging method is not particularly limited and examples thereof include a continuous jetting method and an on-demand method. The on-demand method includes a piezo method, a thermal method, an electrostatic method, etc.

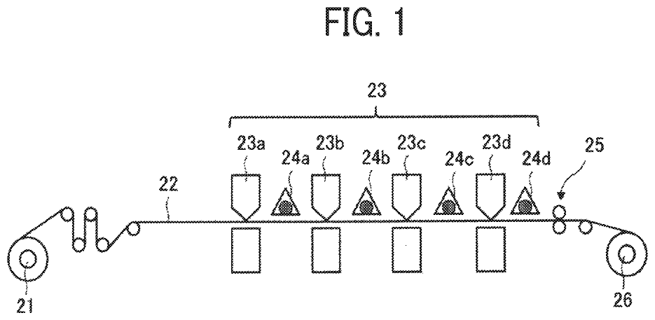

FIG. 1 is a diagram illustrating a two-dimensional image forming apparatus equipped with an inkjet discharging device. Printing units 23a, 23b, 23c, and 23d respectively having ink cartridges and discharging heads for yellow, magenta, cyan, and black active-energy-ray-curable inks discharge the inks onto a recording medium 22 fed from a supplying roller 21. Thereafter, light sources 24a, 24b, 24c, and 24d configured to cure the inks emit active energy rays to the inks, thereby curing the inks to form a color image. Thereafter, the recording medium 22 is conveyed to a processing unit 25 and a printed matter reeling roll 26. Each of the printing unit 23a, 23b, 23c and 23d may have a heating mechanism to liquidize the ink at the ink discharging portion. Moreover, in another embodiment of the present disclosure, a mechanism may optionally be included to cool down the recording medium to around room temperature in a contact or non-contact manner. In addition, the inkjet recording method may be either of serial methods or line methods. The serial methods include discharging an ink onto a recording medium by moving the head while the recording medium intermittently moves according to the width of a discharging head. The line methods include discharging an ink onto a recording medium from a discharging head held at a fixed position while the recording medium continuously moves.

The recording medium 22 is not particularly limited. Specific examples thereof include, but are not limited to, paper, film, metal, or complex materials thereof. The recording medium 22 takes a sheet-like form but is not limited thereto. The image forming apparatus may have a one-side printing configuration and/or a two-side printing configuration.

Optionally, multiple colors can be printed with no or weak active energy ray from the light sources 24a, 24b, and 24c followed by irradiation of the active energy ray from the light source 24d. As a result, energy and cost can be saved.

The recorded matter having images printed with the ink includes articles having printed images or texts on a plain surface of conventional paper, resin film, etc., a rough surface, or a surface made of various materials such as metal or ceramic. In addition, by laminating layers of images in part or the entire of a recording medium, a partially stereoscopic image (formed of two dimensional part and three-dimensional part) and a three dimensional object can be fabricated.

FIG. 2 is a schematic diagram illustrating another example of the image forming apparatus (apparatus to fabricate a 3D object). An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first active-energy-ray-curable composition, and ejection head units 31 and 32 for support and curing these compositions ejects a second active-energy-ray-curable composition having a different composition from the first active-energy-ray-curable composition, while ultraviolet irradiators 33 and 34 adjacent to the ejection head units 31 and 32 cure the compositions. To be more specific, for example, after the ejection head units 31 and 32 for support eject the second active-energy-ray-curable composition onto a substrate 37 for additive manufacturing and the second active-energy-ray-curable composition is solidified by irradiation of an active energy ray to form a first substrate layer having a space for composition, the ejection head unit 30 for additive manufacturing ejects the first active-energy-ray-curable composition onto the pool followed by irradiation of an active energy ray for solidification, thereby forming a first additive manufacturing layer. This step is repeated multiple times lowering the stage 38 movable in the vertical direction to laminate the supporting layer and the additive manufacturing layer to fabricate a solid object 35. Thereafter, an additive manufacturing support 36 is removed, if desired. Although only a single ejection head unit 30 for additive manufacturing is provided to the image forming apparatus illustrated in FIG. 2, it can have two or more units 30.

### <<Cured Product>>

A cured product is a structure derived from, for example, the active-energy-ray-curable composition. In other words, a cured product is a structure formed by curing, for example, the active-energy-ray-curable composition by irradiation with active-energy rays.

### <<Decorated Product>>

A decorated product includes a base material and a decorative part formed of the cured product that is formed over the base material. The base material is not particularly limited and may be appropriately selected depending on the intended purpose. Examples of the base material include paper, thread, fiber, fabrics, leather, metal, plastic, glass, wood, ceramic, or composite materials thereof. Of these, plastic substrates are preferred in terms of processability.

### Examples

The present disclosure will be described below by way of Examples. The present disclosure should not be construed as being limited to these Examples.

### <Cyan Pigment Dispersion Liquid Preparation Example>

A 1 L flask equipped with a mechanical stirrer, a thermometer, a nitrogen gas introducing tube, a reflux condenser, and a dropping funnel was sufficiently purged with a nitrogen gas, and then charged with styrene (11.2 parts by mass), acrylic acid (2.8 parts by mass), lauryl methacrylate (12.0 parts by mass), polyethylene glycol methacrylate (4.0 parts by mass), styrene macromer (4.0 parts by mass), and mercaptoethanol (0.4 parts by mass). The components were then mixed and heated to 65 degrees C.

Next, a mixture solution in which styrene (100.8 parts by mass), acrylic acid (25.2 parts by mass), lauryl methacrylate (108.0 parts by mass), polyethylene glycol methacrylate (36.0 parts by mass), hydroxyethyl methacrylate (60.0 parts by mass), styrene macromer (36.0 parts by mass), mercaptoethanol (3.6 parts by mass), azobismethyl valeronitrile (2.4 parts by mass), and methyl ethyl ketone (18.0 parts by mass) were mixed was dropped into the flask for 2.5 hours. After dropping, a mixture solution of azobismethyl valeronitrile (0.8 parts by mass) and methyl ethyl ketone (18.0 parts by mass) was dropped into the flask for 0.5 hours. After the resultant was aged at 65 degrees C. for 1 hour, azobismethyl valeronitrile (0.8 parts by mass) was added. The resultant was aged for another one hour. After the reaction was completed, methyl ethyl ketone (364 parts by mass) was added into the flask, to obtain a polymer solution A having a concentration of 50 percent by mass (800 parts by mass).

Next, the obtained polymer solution A (28 parts by mass), a phthalocyanine pigment (obtained from Dainichiseika Color & Chemicals Mfg. Co., Ltd., CHROMOFINE BLUE A-220JC) (26 parts by mass), a 1 mol/L potassium hydroxide aqueous solution (13.6 parts by mass), methyl ethyl ketone (20 parts by mass), and ion-exchanged water (13.6 parts by mass) were sufficiently stirred, and then kneaded with a roll mill, to obtain a paste. The obtained paste was added in pure water (200 parts by mass) and stirred sufficiently. Subsequently, methyl ethyl ketone and water were evaporated from the resultant with an evaporator. The resultant dispersion liquid was pressure-filtrated through a polyvinylidene fluoride membrane filter having an average pore diameter of 5.0 micrometers, to remove coarse particles, to obtain a cyan pigment-containing polymer particle dispersion liquid (cyan pigment dispersion liquid) having a pigment proportion of 15 percent by mass and a solid proportion of 20 percent by mass. The 50% cumulative particle diameter (D50) of the obtained cyan pigment dispersion liquid measured with a particle size distribution analyzer (obtained from Nikkiso Co., Ltd., NANOTRAC UPA-EX150) was 56.0 nm.

### Ink Preparation Example

### Examples 1 to 6 and Comparative Examples 1 to 6

Inks of the formulations presented in Tables 1 and 2 below were prepared. Specifically, an organic solvent and water were mixed, and then stirred for 1 hour. Next, an active-energy-ray-polymerizable compound was added to the resultant and stirred for 1 hour. A polymerization initiator, a surfactant, the cyan pigment dispersion liquid, urethane resin particles, and an amine compound were further added to the resultant and stirred for 1 hour. The resultant mixture liquid was pressure-filtrated through a polyvinylidene fluoride membrane filter having an average pore diameter of 5.0 micrometers, to remove coarse particles and dust, to produce the inks of Examples 1 to 6 and Comparative Examples 1 to 6. The unit of the values indicating the mix proportions in Tables 1 and 2 is “percent by mass”.

The supplier names of the products used in Tables 1 and 2 are as follows.
SURFYNOL 440: surfactant, obtained from Nissin Chemical Co., Ltd.
LAROMER LR 8949: active-energy-ray-polymerizable urethane resin particles, obtained from BASF Japan Ltd.
UCECOAT 7571: active-energy-ray-polymerizable urethane resin particles, obtained from Daicel-Allnex Ltd.
UCECOAT 7849: active-energy-ray-polymerizable urethane resin particles, obtained from Daicel-Allnex Ltd.
UCECOAT 7788: active-energy-ray-polymerizable urethane resin particles, obtained from Daicel-Allnex Ltd.
UCECOAT 7200: active-energy-ray-polymerizable urethane resin particles, obtained from Daicel-Allnex Ltd.
UX3945: urethane resin particles, obtained from Sanyo Chemical Industries, Ltd.

### <Ink Evaluation>

Next, scratch resistance, dischargeability, and storage stability of the produced inks were evaluated in the manners described below. The results are presented in Table 1.

### [Scratch Resistance]

By varying the driving voltage of a piezo element under environmental conditions adjusted to 23:0.5 degrees C. and 505% RH, an inkjet recording apparatus (IPSIO GXE-5500, obtained from Ricoh Company, Ltd.) was set to be able to discharge inks in constantly the same amount over a commercially available PET film (with a film thickness of 100 micrometers).

Next, the print mode of the inkjet recording apparatus was set to “plain paper_clean”, and a solid image chart having a size of 5 cm×20 cm was printed over the PET film mentioned above using the produced inks. After the solid image chart was printed, the solid image chart was dried by hot air blowing for 30 seconds from a distance of 20 cm using a heat gun (PJ-206A1) over a hot plate heated to 120 degrees C., and subsequently irradiated with light of a cumulative amount of 500 mJ/cm² in a wavelength range corresponding to the UV-A range (a wavelength range of 350 nm or longer but 400 nm or shorter) using a metal halide lamp, to cure the ink and form a coating film (cured product) having an average thickness of 2 micrometers.

Next, the produced cured product and standard adjacent fabric for test (shirting No. 3) compliant with JIS L 0803 were set in a rubbing fastness tester RT-300 (obtained from Daiei Kagaku Seiki MFG. Co., Ltd., an instrument compliant with a rubbing tester Type II (Gakushin-Type) specified in dyed color fastness test method (JIS L-0849)), and a loading weight (500 g) was also set in the tester. Then, the cured product was reciprocally rubbed a hundred times. The cyan density on the cotton fabric after the test was measured with EXACT SCAN (obtained from X-Rite Inc.), and the density difference with respect to an untested cotton fabric was evaluated. The measurement was evaluated according to the evaluation criteria described below.

### [Evaluation Criteria]

AA: 0.02 or less

A: Greater than 0.02 but 0.2 or less

B: Greater than 0.2

### [Dischargeability]

The produced ink was discharged continuously for 2 minutes from an inkjet discharging apparatus mounted with a MH5220 head (obtained from Ricoh Company, Ltd.), to confirm that the ink was discharged from all nozzles. Next, after the inkjet discharging apparatus was left to stand still for 5 minutes, the number of nozzles that would become unable to discharge through ink discharging of a thousand times was counted, to evaluate “dischargeability” according to the evaluation criteria described below. The inkjet discharging apparatus was set to a driving frequency of 18 kHz, a heating temperature of 25 degrees C., and an ink discharging amount of 15 pL per shot.

### [Evaluation Criteria]

A: Three or less

B: Four or more

### [Storage Stability]

The viscosity of the produced ink (viscosity before storage) was measured. Next, the produced ink was poured into a container made of polyethylene, tightly closed, and stored at 60 degrees C. for 2 weeks. Subsequently, the viscosity (viscosity after storage) was measured. The absolute value of the difference between the viscosity after storage and the viscosity before storage was divided by the viscosity after storage, to calculate a change ratio, which was evaluated according to the criteria described below. The viscosity was measured with a viscometer (RL-500, obtained from TOKI SANGYO CO., LTD.) at 25 degrees C.

### [Evaluation Criteria]

A: Lower than 10%

B: 10% or higher

TABLE 1

| | | | Boiling | | | | | | | |
|---|---|---|---|---|---|---|---|---|---|---|
| | | Molecular | point | D50 | Ex. | | | | | |
| | | weight | (degree C.) | (nm) | 1 | 2 | 3 | 4 | 5 | 6 |
| Polymerization | 2-Hydroxy-2-methyl- | | | | 1.0 | 1.0 | 1.0 | 1.0 | 1.0 | 1.0 |
| initiator | 1-phenylpropanone | | | | | | | | | |
| Organic | 1,2-Propanediol | | | | 8.0 | 13.0 | 3.0 | 5.0 | 8.0 | 3.0 |
| solvent | 1,3-Butanediol | | | | 10.0 | 10.0 | 8.0 | 10.0 | 8.0 | 10.0 |
| | Glycerin | | | | 15.0 | 10.0 | 8.0 | 15.0 | 10.0 | 8.0 |
| Surfactant | SURFYNOL 440 | | | | 1.0 | 1.0 | 1.0 | 1.0 | 1.0 | 1.0 |
| Cyan pigment dispersion liquid | | | | | 3.4 | 3.4 | 3.4 | 3.4 | 3.4 | 3.4 |
| Active-energy- | LAROMER LR8949 | | | 22.6 | 5.0 | | | 6.0 | | |
| ray- | UCECOAT 7571 | | | 34.5 | | 5.0 | | | 8.0 | |
| polymerizable | UCECOAT 7849 | | | 26.2 | | | 13.0 | | | 12.0 |
| compound | UCECOAT 7788 | | | 70.7 | | | | | | |
| (urethane resin | UCECOAT 7200 | | | 65.4 | | | | | | |
| particles) | | | | | | | | | | |
| Urethane resin | UX3945 | | | | | | | | | |
| particles | | | | | | | | | | |
| Amine | Triethylamine | 101.2 | 90 | | | | | | | |
| compound | Dimethylaminoethanol | 117.2 | 161 | | 0.2 | 0.2 | | 0.2 | 0.2 | |
| | 2-Amino-2-methyl-1- | 89.1 | 165 | | | | 0.2 | | | 0.2 |
| | propanol | | | | | | | | | |
| | 2-Amino-2-ethyl-1,3- | 119.2 | 273 | | | | | | | |
| | propanediol | | | | | | | | | |
| Water | | | | | 56.4 | 56.4 | 62.4 | 58.4 | 60.4 | 61.4 |
| Total amount | | | | | 100 | 100 | 100 | 100 | 100 | 100 |
| Evaluation | Scratch resistance | | | | A | A | A | AA | AA | AA |
| result | Dischargeability | | | | A | A | A | A | A | A |
| | Storage stability | | | | A | A | A | A | A | A |

TABLE 2

| | | | Boiling | | | | | | | |
|---|---|---|---|---|---|---|---|---|---|---|
| | | Molecular | point | D50 | Comp. Ex. | | | | | |
| | | weight | (degree C.) | (nm) | 1 | 2 | 3 | 4 | 5 | 6 |
| Polymerization | 2-Hydroxy-2-methyl- | | | | 1.0 | 1.0 | 1.0 | 1.0 | 1.0 | 1.0 |
| initiator | 1-phenylpropanone | | | | | | | | | |
| Organic | 1,2-Propanediol | | | | 8.0 | 13.0 | 3.0 | 5.0 | 5.0 | 5.0 |
| solvent | 1,3-Butanediol | | | | 10.0 | 10.0 | 8.0 | 10.0 | 10.0 | 10.0 |
| | Glycerin | | | | 15.0 | 10.0 | 8.0 | 15.0 | 15.0 | 15.0 |
| Surfactant | SURFYNOL 440 | | | | 1.0 | 1.0 | 1.0 | 1.0 | 1.0 | 1.0 |
| Cyan pigment dispersion liquid | | | | | 3.4 | 3.4 | 3.4 | 3.4 | 3.4 | 3.4 |
| Active-energy- | LAROMER LR8949 | | | 22.6 | 5.0 | | | | | |
| ray- | UCECOAT 7571 | | | 34.5 | | 5.0 | | | | |
| polymerizable | UCECOAT 7849 | | | 26.2 | | | 13.0 | | | |
| compound | UCECOAT 7788 | | | 70.7 | | | | 8.0 | | |
| (urethane resin | UCECOAT 7200 | | | 65.4 | | | | | 8.0 | |
| particles) | | | | | | | | | | |
| Urethane resin | UX3945 | | | | | | | | | 8.0 |
| particles | | | | | | | | | | |
| Amine | Triethylamine | 101.2 | 90 | | | 0.1 | 0.2 | | | |
| compound | Dimethylaminoethanol | 117.2 | 161 | | | | | | | |
| | 2-Amino-2-methyl-1- | 89.1 | 165 | | | | | 0.2 | 0.2 | 0.2 |
| | propanol | | | | | | | | | |
| | 2-Amino-2-ethyl-1,3- | 119.2 | 273 | | 0.2 | 0.1 | | | | |
| | propanediol | | | | | | | | | |
| Water | | | | | 56.4 | 56.4 | 62.4 | 56.4 | 56.4 | 56.4 |
| Total amount | | | | | 100 | 100 | 100 | 100 | 100 | 100 |
| Evaluation | Scratch resistance | | | | A | A | AA | B | B | B |
| result | Dischargeability | | | | B | B | B | B | B | B |
| | Storage stability | | | | A | A | B | A | A | A |

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An active-energy-ray-curable composition comprising:
an active-energy-ray-polymerizable compound comprising resin particles having a 50% cumulative particle diameter (D50) of 5 nm or greater but 50 nm or less;
an amine compound having a molecular weight of 118.0 or less and a boiling point of 120 degrees C. or higher; and
water,
wherein a proportion of the water in the active-energy-ray-curable composition is 50.0 percent by mass or greater.

2. The active-energy-ray-curable composition according to claim 1,
wherein the active-energy-ray-polymerizable compound comprises an active-energy-ray-polymerizable urethane resin.

3. The active-energy-ray-curable composition according to claim 1,
wherein a proportion of the active-energy-ray-polymerizable compound in the active-energy-ray-curable composition is 6.0 percent by mass or greater but 12.0 percent by mass or less.

4. The active-energy-ray-curable composition according to claim 1,
wherein the amine compound has a molecular weight of 100.0 or less and a boiling point of 120 degrees C. or higher but 200 degrees C. or lower.

5. The active-energy-ray-curable composition according to claim 1,
wherein the amine compound comprises at least one selected from the group consisting of compounds represented by General formula (1) below and compounds represented by General formula (2) below, 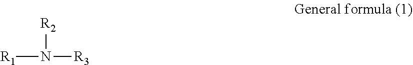
wherein in General formula (1), R₁, R₂, and R₃ each independently represent a hydrogen atom, an alkoxy group containing from one through four carbon atoms, an alkyl group containing from one through six carbon atoms, or a hydroxyethyl group, where all of R₁, R₂, and R₃ do not represent hydrogen atoms at the same time, 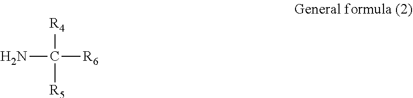
wherein in General formula (2), R₄, R₅, and R₆ each independently represent a hydrogen atom, an alkyl group containing from one through four carbon atoms, or a hydroxymethyl group.

6. The active-energy-ray-curable composition according to claim 1,
wherein the amine compound comprises at least one selected from the group consisting of 1-amino-2-propanol, 3-amino-1-propanol, N-methylethanolamine, N,N-dimethylethanolamine, 1-amino-2-methyl-propanol, dimethylaminoethanol, and 2-amino-2-methyl-1-propanol.

7. The active-energy-ray-curable composition according to claim 1,
wherein the amine compound comprises at least one selected from the group consisting of dimethylaminoethanol and 2-amino-2-methyl-1-propanol.

8. The active-energy-ray-curable composition according to claim 1,
wherein a proportion of the amine compound in the active-energy-ray-curable composition is 0.05 percent by mass or greater but 2.0 percent by mass or less.

9. The active-energy-ray-curable composition according to claim 1,
wherein a mass ratio the amine compound to the active-energy-ray-polymerizable compound is 0.01 or greater but 0.10 or less.

10. An active-energy-ray-curable ink comprising
the active-energy-ray-curable composition according to claim 1.

11. An active-energy-ray-curable inkjet ink comprising
the active-energy-ray-curable composition according to claim 1.

12. A stored container comprising:
a container; and
the active-energy-ray-curable composition according to claim 1 stored in the container.

13. A two-dimensional or three-dimensional image forming apparatus comprising:
a containing unit containing the active-energy-ray-curable composition according to claim 1;
an applying unit configured to apply the active-energy-ray-curable composition contained in the containing unit; and
an irradiating unit configured to irradiate the active-energy-ray-curable composition applied with active energy rays.

14. A two-dimensional or three-dimensional image forming method comprising:
applying the active-energy-ray-curable composition according to claim 1; and
irradiating the active-energy-ray-curable composition applied with active energy rays.

15. A cured product derived from the active-energy-ray-curable composition according to claim 1.
